(19) United States
(12) Patent Application Publication
(10) Pub. No.: US 2005/0269269 A1
(43) Pub. Date: Dec. 8, 2005

(54) Perchlorate removal process

(76) Inventors: Peter L. Jensen, San Diego, CA (US); Gerald A. Guter, San Clemente, CA (US); Janet A. Solomon, San Clemente, CA (US)

Correspondence Address: FOLEY & LARDNER LLP, 1530 PAGE MILL ROAD, PALO ALTO, CA, 94304, US

(21) Appl. No.: 11/131,661

(22) Filed: May 17, 2005

Related U.S. Application Data
(60) Provisional application No. 60/572,636, filed on May 18, 2004.

(51) Int. Cl. C02F 1/42

(52) U.S. Cl. 210/670; 210/683

(57) ABSTRACT

Systems and methods for removing perchlorate load from ion exchange resin regeneration brines.

### CROSS-REFERENCE TO RELATED PATENT APPLICATIONS

This application is a an application claiming the benefit under 35 USC 119(e) U.S. application Ser. No. 60/572,636, filed May 18, 2004, incorporated herein by reference in its entirety.

### BACKGROUND OF THE INVENTION

1. Field of the Invention

This invention pertains to the field of water treatment and to the use of ion exchange resins to remove perchlorate ions from aqueous feed stocks ranging from domestic, industrial and agricultural water supplies such as drinking water to brines and other aqueous streams. More particularly it relates to a method for removing perchlroate load from perchlorate-loaded brines generated in water treatment settings.

2. Background Information

Ammonium perchlorate has been used for the past 50 years as an oxidizer component in solid explosives and solid propellants for rockets, missiles and fireworks. It is estimated that well over 90% of the ammonium perchlorate produced in the United States is used in these applications. Casual handling of perchlorates and perchlorate-laden effluents by manufacturers, and the build up of poorly-contained stockpiles of outdated missile and rocket fuels have resulted in perchlorate contamination of surface water and ground water supplies. Perchlorate contamination is a growing problem in at least 14 Western states in the United States and has been reported in Europe as well.

The California Department of Health Services has established an action level for perchlorate of 18 ug/l. This is based upon the potential for perchlorate to inhibit the uptake of iodine by the thyroid gland. Perchlorate levels of up to several hundred ug/l have been found in ground water in California and other states.

Two approaches to removing perchlorate from water supplies are being researched extensively—biological destruction and ion exchange. Biological destruction using various bacterial strains has been described at the Federal Remediation Technologies Roundtable General Meeting held on May 30, 2001 where Jeffrey Marqusee described how biological organisms could attack perchlorate in subsurface environments. Similar studies were also reported at that meting by Paul Hatzinger (Poster Number 43) and by John D. Coates (Poster Cleanup CU 45).

Ion exchange is attractive because perchlorate has a very high affinity for common polystyrene-based strong base anion exchange resins. However, state of the art practice does not provide a practical and convenient method for regeneration of the resin. This is due at least in part to perchlorate's affinity for the common resins being so strong that very large quantities of concentrated sodium chloride brine are required to displace the perchlorate during regeneration. Several hundred pounds of sodium chloride regenerant per cubic foot of resin at salt concentrations of from 6% to saturation are typically used. Alternatively, the resins can be used once for perchlorate adsorption and then thrown away instead of being regenerated.

The need for regeneration or disposal is rendered particularly troublesome because the feed waters, in addition to containing tens of parts per BILLION of perchlorate also contain many parts per MILLION of nitrate and sulfate which are also absorbed onto the same resin that removes the perchlorate contamination. This means that the resin becomes loaded and looses performance with only a small fraction of its total capacity taken up with perchlorate and a major fraction loaded with the other, more populous contaminant species. Similarly, the brine which is produced when the loaded resin is regenerated contains not only perchlorate but also significantly larger amounts of nitrate and sulfate

In all of these cases, a difficult-to-deal-with perchlorate-loaded end product is formed. The loaded resin can not be safely discarded in ordinary land fills and the like because of fears of its perchlorate content reentering the environment. Attempts to bacterially break down the perchlorate content of the concentrated sodium chloride brine have been unsuccessful because the bacteria are generally inactivated by the high salt levels. For example, Tina M. Gingras and Jacimaria R. Batista reported in J. Environ. Monit. (2002),4, 96-101, that as little as 0.5% sodium chloride present in a bioremediation environment lowered perchlorate degradation activity by 30% while 1.0% sodium chloride reduced activity by 60%.

What is needed, and what this invention provides, is a process for removing perchlorate from perchlorate-loaded ion exchange resins or from perchlorate loaded brines without generating large quantities of intractable perchlorate regeneration products.

### STATEMENT OF THE INVENTION

We have now discovered a method for alleviating the problem of high perchlorate levels in perchlorate-loaded brines. This method reduces the perchlorate levels in the brine to a point that the brine can be recycled if desired but more commonly so that the brine can be disposed of by conventional routes without being considered a hazardous waste material.

This method can be embodied specifically as a method for treating brine using ion exchange. It can also be embodied as part of an overall ion exchange process for removing perchlorate from water streams including ground water, drinking water, waste water and the like. Both embodiments will be discussed.

When embodied as a method for removing perchlorate contamination from a perchlorate-containing feed water, the feed water should additionally contain nitrate and/or sulfate. In this setting the method involves the steps of

a. contacting the perchlorate and nitrate and/or sulfate-containing feed water with a first anion exchange resin having an affinity for perchlorate and nitrate and/or sulfate thereby removing perchlorate and nitrate and/or sulfate from the feed water and forming a reduced perchlorate and nitrate and/or sulfate content product water and perchlorate and nitrate and/or sulfate-loaded first ion exchange resin. This first ion exchange resin is typically an acrylic strong base anion exchange resin.

b. Separating the reduced perchlorate and nitrate and/or sulfate content product water from the perchlorate and nitrate and/or sulfate-loaded first ion exchange resin.

c. contacting the perchlorate and nitrate and/or sulfate-loaded first ion exchange resin with feed brine having a perchlorate and nitrate and/or sulfate-desorbing salt content under perchlorate and nitrate and/or sulfate desorbing conditions thereby forming a treated first ion exchange resin having reduced perchlorate and nitrate and/or sulfate load relative to the perchlorate and nitrate and/or sulfate-loaded first ion exchange resin and a perchlorate and nitrate and/or sulfate loaded first product brine.

d. separating the perchlorate and nitrate and/or sulfate loaded first product brine from the treated first ion exchange resin,

e. contacting the perchlorate and nitrate and/or sulfate-loaded first product brine with a second ion exchange resin, this second resin having enhanced affinity for perchlorate over nitrate and/or sulfate in the presence of nitrate and sulfate-desorbing salt content brine, thereby selectively removing perchlorate from the first product brine and forming a second product brine having a reduced perchlorate level relative to the perchlorate level of the first product brine and a perchlorate-loaded second ion exchange resin,

f. Separating the perchlorate loaded second ion exchange resin from the second product brine, and

g. disposing of or recycling the perchlorate-loaded second ion exchange resin.

When embodied as a method for removing perchlorate contamination from a perchlorate-loaded brine the brine should additionally contain nitrate and/or sulfate. In this setting the method involves the steps of

a. obtaining a perchlorate-containing feed brine additionally containing nitrate and/or sulfate and an ion-exchange-absorption-suppressing concentration of sodium chloride

b. contacting the perchlorate and nitrate and/or sulfate- and sodium chloride containing feed brine with an ion exchange resin having enhanced affinity for perchlorate over and nitrate and/or sulfate in the presence of an ion exchange absorption-suppressing concentration of sodium chloride thereby selectively removing perchlorate from the feed brine and forming a reduced perchlorate content product brine having a reduced perchlorate level relative to the perchlorate level of the feed brine and a perchlorate-loaded ion exchange resin and

c. disposing of or recycling the product brine.

In additional aspects, this invention provides equipment and systems for carrying out these methods and processes.

### BRIEF DESCRIPTION OF THE DRAWINGS

This invention will be further described with reference being made to the accompanying drawings in which both of the Figures are semi-cross-sectional schematic elevational views of representative systems embodying this invention.

FIG. 1 shows the basic system of FIG. 2 incorporated into an overall system for treating a perchlorate-laden brine stream generated in a water treatment setting; and

FIG. 2 shows a basic system of this invention for removing perchlorate from a perchlorate-containing brine.

### DESCRIPTION OF PREFERRED EMBODIMENTS

The present invention employs ion exchange to capture and isolate perchlorate load from prechlorate-loaded salt brines. Accordingly, this description of preferred embodiments will be broken down into the following sections:

The Ion Exchange Resins

Representative Feed Stocks

Overall Process Descriptions and Process Flows

Process Conditions

Water Treatment with Microorganisms—Coated Resin

These sections will then be followed by Examples

The Ion Exchange Resins

Ion exchange resins appear in two contexts in this invention. The first is as resins for removing perchlorate contamination from water. The second is as resins for selectively isolating and removing perchlorate load from sulfate and/or nitrate rich, perchlorate-loaded sodium chloride brines such as would be formed in the regeneration of the first resins used in the water purification step.

The first resin is a strong base anion exchange resin preferably on an acrylic backbone. These resins, and other suitable equivalents, are characterized by having affinity for sulfate and nitrate as well as perchlorate and by not having an overwhelming preference for perchlorate. Representative suitable acrylic resins include Purolite A-850, 860, and 870; Rohm and Haas Amberlite IRA 458 and 478 and Bayer Lewatit AP 246 and 247A. Resins classed as weak base resins can be used if the pH permits their ionization Representative materials here include Purolite A-830, 840 and 845 and their equivalents.

The second resins are also classed as strong base resins. These second resins should exhibit a preference for perchlorate over sulfate and nitrate such that at the conditions of use, perchlorate is preferentially absorbed in the presence of significant concentrations of sodium chloride, which concentrations are referred to herein as “nitrate and sulfate desorbing concentrations of salt”. Under these conditions perchlorate will eventually significantly and preferentially load the second resin.

These second resins are based on various polymer structures such as polystyrene with cross-linkers and with appropriate active groups such as quaternary ammoniums attached. Representative resins include:
Prolate Strong Base Resins Type 1 and Type 2
Amberlite IRA-400
Amberlite IRA-900
Dowex SBR
Ionac ASB-1
Ionac AFP-100
Dowex SBR-P
Dowex 11
Duolite A-102-D
Ionac ASB-2
Amberlite IRA-93
Amberlite IR-45
Purolite A-400
Purolite A-520-E
Purolite A-600
Ionac A-260
Dowex WGR
Sybron SR6
Sybron SR7
Reillex™HPQ Resins (based on polyvinyl pyridine polymers)
Nitrex
Resintech SIR 100
Rohm and Haas Acrylic Resin

Other ion exchange resins which are applicable to the invention are strong acid or weak base type resins such as:
Amberlite IR-120
Ionac C-20
Prolate C-100
Ionac C-270
Amberlite-200
Ionac CFS

Generally, the strong base type I resins, particularly those based on polystyrene backbones, give good overall results removing perchlorate and are preferred.

Among these resins, excellent results can been attained using the Sybron SR6 resin. This is a resin having quaternary amine functionalities and three butyl groups in these quaternary amine groups. Sybron SR7 resin can give similarly excellent results. This is a similar quaternary amine-based resin but with three propyl groups in its quaternary amine groups. The SR7 resin has been observed to have a particularly high selectivity for perchlorate ions. Other resins which are preferred as second resins include Purolite 520e and Amberlite IRA 966.

Representative Feed Stocks

The brines which are treated with the second resin can be formed during the regeneration of first resins which themselves have become partially or relatively completely loaded with perchlorate, nitrate and sulfate ion relative to their perchlorate-adsorbing capacity in water purification service. In most water purification settings, it is desirable to remove perchlorate quite completely. Often as a resin becomes partially exhausted on an absolute scale its performance in water purification drops off slightly. This can be signal to consider the first resin “exhausted” and to regenerate it with brine. This can occur when as few as 30 or 40% of the total available capacity has been used up. This phenomenon will be seen in the present examples where resins were deemed suitable for regeneration when about 40-45% of their total capacity was exhausted. These resins can become loaded in service in an ion exchange-based water purification unit. The term “water purification” is used in a broad sense to include the purification of not only ground water, surface run off, water found in bodies of water, streams, rivers and the like drinking water source but also to include commercial, industrial and agricultural water sources such as plant effluents, agrarian run offs, sewage and the like.

In all of these settings, the water being purified must contain an unacceptably high level of perchlorate ion. That is a level of perchlorate ion greater than a few parts per billion. This feed water can contain up to as many as several parts per million of perchlorate and in some industrial settings can contain tens or even up to hundred of parts per million of perchlorate. It will be appreciated that the invention would work with resins loaded by treating water with even higher perchlorate contents. In all of these settings, it is very likely, if not the rule, that there will be other anions which will be picked up by the ion exchange resin. Many of these ions such as sulfate and nitrate, while not as troublesome as perchlorate, are not particularly desirable in drinking water so their exchange onto the resin is generally welcomed. These ions are typically present at levels considerably higher, often by factors of a thousand or more, than perchlorate. A representative feed water of this type could contain from about 10 to 250 ppb of perchlorate and 1 to 200 ppm of nitrate and/or 10-200 ppm of sulfate. A typical representative contaminated water feed stream might contain 30 ppm nitrate, 120 ppm sulfate and 30 ppb perchlorate.

Other ions such as heavy metal-based anions for example arsenate are also regularly removed from the feed water when it is contacted with the resin. Thus a loaded resin bed will typically be substantially loaded with perchlorate ions but also contain nitrate and sulfate as its predominant load.

When such a loaded resin is treated with brine having a sodium chloride content of at least about 4% and more typically from 5% by weight to about 20% by weight and more typically about 6% by weight to about 19% be weight, this will yield a spent brine containing from about 1 ppm to about 20 ppm (or higher, if possible) levels of perchlorate as well as at least about 500 ppm and especially from about 1000 to about 10,000 ppm nitrate and at least about 800 ppm and especially from about 1500 ppm to about 15,0000 ppm of sulfate in addition to at least about 4% by weight and especially from about 5% to about 19% and especially from about 6% to about 18% by weight sodium chloride.

Perchlorate is one of the most readily adsorbed ions and can displace other species such as nitrate and sulfate from the second resins. Thus, in practice the second ion exchange resin is commonly sent to regeneration or disposal once it is loaded with perchlorate as the result of direct absorption out of the brine and also displacement of nitrate and sulfate which might be attracted to the second resin

Overall Process Descriptions and Process Flows

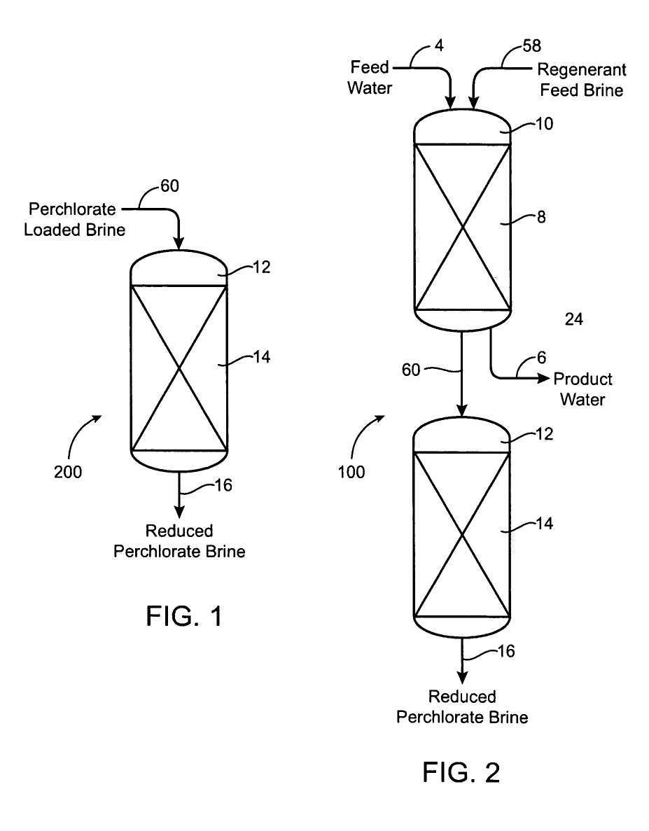

FIG. 1 shows a representative system 100 for embodying this invention as part of an overall process for purifying perchlorate-contaminated water. Perchlorate-loaded resin 8 is formed in vessel 10 by initially charging fresh resin to the vessel and loading it with perchlorate by passing perchlorate-laden (10-40 ppb perchlorate) untreated water over it via line 4. The feed additionally contains sulfate and/or nitrate in the concentrations described above The resin will adsorb the perchlorate, nitrate and sulfate in exchange for a nonperchlorate ion (usually chloride) and yield perchlorate-free treated water which can be removed via line 6. This loading is exactly what happens when the resin 8 is in service purifying water.

The perchlorate, nitrate and/or sulfate levels in the product water are checked periodically or continuously. Eventually, the resin bed 8 becomes load and its efficiency removing these three ions drops off.

To regenerate the spent resin, a brine solution, typically containing on the order of 4-20, and especially 5 to 19% by weight sodium chloride, is fed via line 58 and passed over resin bed 8 where it displaces the perchlorate, nitrate and sulfate ions present on the spent resin. The effluent brine from vessel 10, which contains perchlorate, nitrate and sulfate ions, is transferred via line 60 to vessel 12 which contains a perchlorate-selective resin as bed 14. Under these strong brine conditions, this resin bed adsorbs the perchlorate onto the resin in bed 14 and yields a relatively perchlorate-free effluent out of vessel 12. This effluent may initially contain relatively reduced levels of nitrate and sulfate as well but at these brine conditions the binding of nitrate and or sulfate tot eh second resin is very weak if at all and as additional perchlorate arrives and is absorbed onto the resin there is significant disorption of sulfate and nitrate. This means that this second resin bed can be kept in service for a prolonged period before it begins to drop significantly in perchlorate absorption efficiency. This effluent is removed via line 16, most typically for discard/disposal into a commercial brine disposal line or well. This is advantageous in that the untreated brine stream with its substantial perchlorate concentration can not be fed into typical commercial brine disposal lines and wells.

Once the resin bed 14 is loaded with perchlorate as determined by an increase in perchlorate level in the effluent, the flow of brine is stopped and the resin in the bed is removed for disposal via incineration or by burial or the like. As will be pointed out below, the total volume of water that can be treated and the total volume of brine as well is very large and it is economic to dispose of the second resin when it is loaded.

Turning to FIG. 2 a very basic system 200 is shown. This is the second stage of system 100 in which perchlorate, nitrate and sulfate-loaded brine is fed via line 60 to vessel 12 where it contacts resin bed 14 to produce a reduced perchlorate brine product which is removed via line 16. The purpose of this Figure is to illustrate that while it is most common for this stage to be part of an overall process it is not a requirement and it is possible for the selective absorption of perchlorate from a high salt content brine that contains nitrate and sulfate to be carried out independent of the water purification step

Process Conditions

Contacting the perchlorate-loaded feed water with the first resin can be carried out upflow or downflow, the flow rates that are used are conventional, such as from about 0.1 to about 100 bed volumes of water fed per hour. After the resin is showing break through for nitrate, sulfate or perchlorate (generally after from about 100 to about 500 bed volumes of water) the flow of water is halted and regenerative brine is added. This can involve about one bed volume of brine being added and allowed to contact the resin for a period in the range of a few minutes or longer. More than about one bed volume of brine can be used, if desired.

The second stage, wherein the loaded brine is contacted with the perchlorate-selective resin is carried out under similar conditions. It is generally seen that the second resin bed can be used to treat multiple bed volumes of brine generated in a plurality of regeneration steps for example, from about 50 to about 1000 and especially about 75 to 500 bed volumes of brine can be treated by a single bed of selective resin. Thus, it is possible to treat as many as a half million bed volumes of waste water before a second resin bed needs to be removed and disposed of.

### EXAMPLE 1

### Application to Brine Treatment

The removal of perchlorate from a resin as described above can be applied to a resin loaded with perchlorate from a brine that is itself generated in a resin regeneration process as follows.

Ground water containing about 20 ppb of perchlorate and part per million levels of nitrate and sulfate can be treated with an acrylic resin. Approximately 500 bed-volumes of water can be treated. The resin is then regenerated by contact with a perchlorate and sulfate and/or nitrate dissolving salt brine (5-20% w NaCl). This desorbs the perchlorate, nitrate and sulfate off of the resin. The concentration of perchlorate in the brine will be about 10 mg/L. Such a brine with this much perchlorate cannot be disposed of because of regulatory requirements. The brine which is considered to have a nitrate and sulfate absorption suppressing level of salt, however, can be treated with a perchlorate specific resin, such as A520E resin which preferentially adsorbs the perchlorate but also will typically pick up some nitrate and/or sulfate which is thereafter displaced by additional perchlorate. When the perchlorate is transferred to the A520E resin, the concentration of perchlorate in the waste brine will be below detection levels and the treated brine is acceptable for disposal. The concentration of perchlorate on the A520E resin will be about 300 mg/L.

1. A method for removing perchlorate contamination from a perchlorate-containing feed water additionally containing nitrate and/or sulfate comprising
a. contacting the perchlorate and nitrate and/or sulfate-containing feed water with a first anion exchange resin having an affinity for perchlorate and nitrate and/or sulfate thereby removing perchlorate and nitrate and/or sulfate from the feed water and forming a reduced perchlorate and nitrate and/or sulfate content product water and perchlorate and nitrate and/or sulfate-loaded ion exchange resin,
b. separating the reduced perchlorate and nitrate and/or sulfate content product water from the perchlorate and nitrate and/or sulfate-loaded ion exchange resin,
c. contacting the perchlorate and nitrate and/or sulfate -loaded ion exchange resin with feed brine having a perchlorate and nitrate and/or sulfate desorbing salt content under perchlorate and nitrate and/or sulfate desorbing conditions thereby forming a treated ion exchange resin having reduced perchlorate and nitrate and/or sulfate load relative to the perchlorate and nitrate and/or sulfate-loaded first ion exchange resin and a perchlorate and nitrate and/or sulfate loaded first product brine
d. separating the perchlorate and nitrate and/or sulfate loaded product brine from the treated first ion exchange resin,
e. contacting the perchlorate and nitrate and/or sulfate-loaded first product brine with a second ion exchange resin having enhanced affinity for perchlorate over nitrate and/or sulfate in the presence of nitrate and sulfate desorbing salt content brine, thereby selectively removing perchlorate from the first product brine and forming a second product brine having a reduced perchlorate level relative to the perchlorate level of the first product brine and a perchlorate-loaded second ion exchange resin.
f. separating the perchlorate-loaded second ion exchange resin from the second product brine, and
g. disposing of or recycling the perchlorate-loaded second ion exchange resin.

2. A method for removing perchlorate contamination from a perchlorate-containing feed brine additionally containing nitrate and/or sulfate and an ion-exchange-absorption-suppressing concentration of sodium chloride comprising
a. contacting the perchlorate and nitrate and/or sulfate- and sodium chloride containing feed brine with an ion exchange resin having enhanced affinity for perchlorate over and nitrate and/or sulfate in the presence of an ion exchange absorption-suppressing concentration of sodium chloride thereby selectively removing perchlorate from the feed brine and forming a reduced perchlorate content product brine having a reduced perchlorate level relative to the perchlorate level of the feed brine and a perchlorate-loaded ion exchange resin and
b. disposing of or recycling the product brine.

3. The method of claim 1 wherein the product brine is disposed of.

4. The method of claim 2 wherein the product brine is disposed of.

5. The method of claim 1 wherein the first anion exchange resin is an acrylic resin

6. The method of claim 1 wherein the first ion exchange resin is a strong base resin.

7. The method of claim 1 wherein the second anion exchange resin is a strong base resin.

8. The method of claim 2 wherein the anion exchange resin is a strong base resin.

9. The method of claim 6 wherein the second anion exchange resin is selected from SR-6, SR-7 and A 520 e.

10. The method of claim 7 wherein the resin is selected from SR-6, SR7 and A 520 e.

11. The method of claim 1 wherein the salt concentration is 5-20% w.

12. The method of claim 2 wherein the salt concentration is 5-20% w.
